(19) United States
(12) Patent Application Publication
(10) Pub. No.: US 2025/0377823 A1
(43) Pub. Date: Dec. 11, 2025

(54) DYNAMIC WEAR RATIO MANAGEMENT

(71) Applicant: Micron Technology, Inc., Boise, ID (US)

(72) Inventors: Hanping Chen, San Jose, CA (US); Guang Hu, Mountain View, CA (US); Murong Lang, San Jose, CA (US)

(21) Appl. No.: 19/223,389

(22) Filed: May 30, 2025

Related U.S. Application Data
(60) Provisional application No. 63/658,342, filed on Jun. 10, 2024.

(51) Int. Cl. G06F 3/06

(52) U.S. Cl. CPC G06F 3/0652; G06F 3/0604; G06F 3/0679

(57) ABSTRACT

A system includes a memory device and a processing device operatively coupled to the memory device. The processing device is to perform operations including performing a program operation on a block of the memory device. The operations further include retrieving, from a metadata structure associated with a block of the memory device, a value reflecting a type and a corresponding number of erase operations performed on the block of the memory device. The operations further include determining a wear ratio based on the value reflecting the type and the corresponding number of erase operations and the program operation. The operations further include updating, based on the determined wear ratio, a media endurance metric value of the block of the memory device.

### REFERENCE TO RELATED APPLICATION

This application claims the priority benefit of U.S. Provisional Patent Application No. 63/658,342, filed Jun. 10, 2024, the entirety of which is incorporated herein by reference.

### TECHNICAL FIELD

Embodiments of the disclosure relate generally to memory sub-systems, and more specifically, to dynamic wear ratio management for dynamic pool compatible systems.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The present disclosure will be understood more fully from the detailed description given below and from the accompanying drawings of various embodiments of the disclosure.

FIG. 1A illustrates an example computing system that includes a memory sub-system according to embodiments.

FIG. 1B is a block diagram of a memory device in communication with a memory sub-system controller of a memory sub-system, in accordance with some embodiments.

FIG. 2 illustrates dynamic wear ratio management in a QLC die of a memory device, according to various embodiments.

FIG. 3 is a flow chart of a method for dynamic wear ratio management for dynamic pool compatible systems, according to various embodiments.

FIG. 4 is a block diagram of an example computer system in which embodiments of the present disclosure can operate.

### DETAILED DESCRIPTION

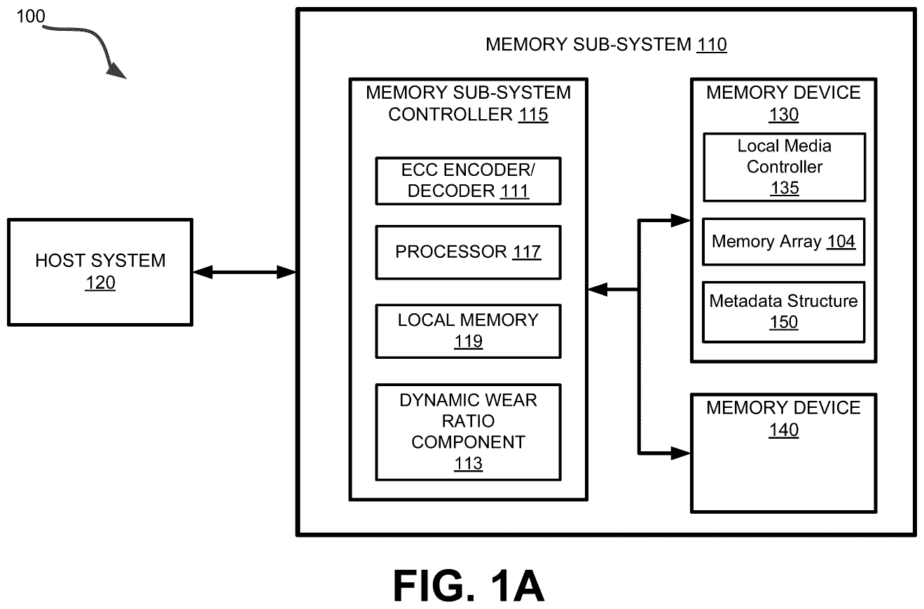

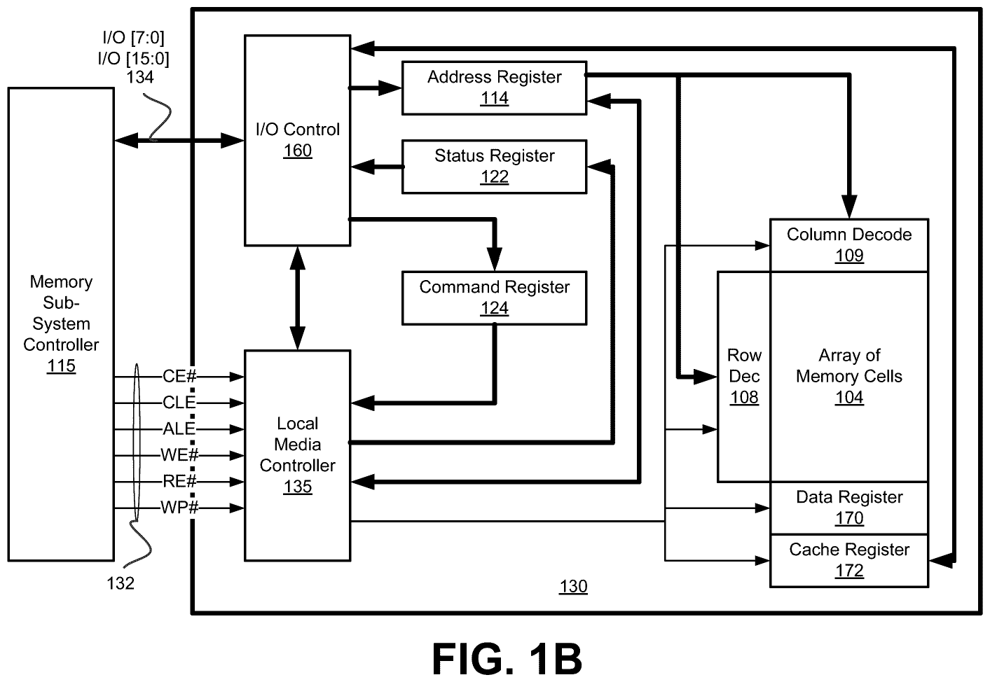

Aspects of the present disclosure are directed to dynamic wear ratio management for dynamic pool compatible systems. A memory sub-system can be a storage device, a memory module, or a combination of a storage device and memory module. Examples of storage devices and memory modules are described below in conjunction with FIGS. 1A and 1B. In general, a host system can utilize a memory sub-system that includes one or more components, such as memory devices that store data. The host system can provide data to be stored at the memory sub-system and can request data to be retrieved from the memory sub-system.

A memory sub-system can include high density non-volatile memory devices where retention of data is desired when no power is supplied to the memory device. One example of non-volatile memory devices is a not-and (NAND) memory device. Other examples of non-volatile memory devices are described below in conjunction with FIGS. 1A and 1B. A non-volatile memory device is a package of one or more dies. Each die can include of one or more planes. Each plane carries a matrix of memory cells formed onto a silicon wafer and joined by conductors referred to as wordlines and bitlines, such that a wordline joins multiple memory cells forming a row of the matric of memory cells, while a bitline joins multiple memory cells forming a column of the matric of memory cells.

For some types of non-volatile memory devices (e.g., NAND devices), each plane includes of a set of physical blocks. Each block includes of a set of pages. Each page includes of a set of memory cells (“cells”). A cell is an electronic circuit that stores information. Depending on the cell type, a cell can store one or more bits of binary information, and has various logic states that correlate to the number of bits being stored. The logic states can be represented by binary values, such as “0” and “1”, or combinations of such values.

Within a memory sub-system, a translation unit (TU) can serve as a unit of data management. In some embodiments of the present disclosure, a TU can be a page, a block, a superblock, and/or the like. For the purposes of illustration, this disclosure primarily uses ‘blocks’ as examples of TUs. However, the description outlined herein can extend beyond blocks, covering other forms of TUs such as pages, superblocks, etc. The present disclosure can be applicable across different types of TUs (e.g., pages, block, superblocks, etc.), enabling adaptation of the present disclosure to a wide range of operational scenarios and memory system architectures. A block hereinafter refers to a unit of the memory device used to store data and can include a group of memory cells, a wordline group, or a wordline.

In the context of NAND flash memory, the management of memory blocks through dynamic pools—logical groupings of blocks configured as specific types of memory cells—can help to increase memory utilization. A dynamic pool can refer to a configurable portion (e.g., a logical group of blocks) of the memory device that offers flexible data storage management. A dynamic pool can include multiple memory blocks that can be dynamically reconfigured based on the current storage requirements and operational strategies (e.g., of a host system). Dynamic pooling can improve data storage efficiency, enhance the lifespan of the memory, and ensure optimal performance under a wide range of operating conditions by allowing the reallocation of memory resources in response to varying system demands.

The management of dynamic pools can be accomplished by a memory controller, which can be configured to adjust the composition and function of these pools in real-time. This can include transitioning blocks between different data storage configurations (e.g., SLC, MLC, TLC, QLC, XLC, etc.) to balance performance needs with storage density requirements. Further, a dynamic pool can be reconfigured or resized according to evolving needs of a memory device. This may involve the integration of newly erased blocks into the pool, the removal of blocks nearing their wear limit, or the reconfiguration of blocks to support different types of memory operations.

Using dynamic pools can allow for the adjustment of pool sizes in response to system requirements, aiming to minimize spare block allocation and reduce overall die sizes. However, the use of dynamic pools can pose challenges, primarily due to the current inability to accurately record the wear ratios of memory cells across different programming operation combinations. Programming operation combinations can be referred to as erase-program schemes. Erase-program schemes can be sequences of erase and program operations. For example, one or more erase operations can be performed on a memory cell followed by a programming operation. The exact combination of the erase operations and the program operation performed on the cell can be referred to as the erase-program scheme. Some implementations of dynamic pooling do not track erase-program schemes which can lead to inaccurate PEC counts due to shifting dynamic pools as described below.

Some implementations of dynamic pooling that employ the strategic pre-erasure of memory blocks in anticipation of specific memory type requirements, can encounter shifts in system demands that require a change in the intended use of these blocks. For example, a block might initially be pre-erased as Single-Level Cell (SLC) memory, optimizing it for quick access and high endurance based on predicted data storage needs. However, evolving host data requirements may subsequently necessitate the utilization of this block for Triple-Level Cell (TLC) memory instead, which offers higher data density but differs in endurance and access speed characteristics. To accommodate this shift, a TLC erase operation (e.g. a TLC type low stress refresh erase (LSRE)) can be performed on the already SLC pre-erased block to reformat it for TLC program operations. This process, while flexible, introduces challenges in accurately tracking PECs for the block. Further challenges arise in assessing wear ratios as the block undergoes multiple erase operations for different memory types before a program operation. The inability to assign precise wear ratios and record accurate PEC counts, particularly when accounting for varied erase-program schemes diminishes the effectiveness of dynamic pools and also leads to the premature retirement of memory blocks due to inaccurately high wear assessments. The inability to assign precise wear ratios and record accurate PEC counts further results in reduced operational lifetimes for dynamic pool compatible memory devices and in some cases, when wear assessments are underestimated, blocks of a memory device can be unintentionally used past end of life (EOL), leading to system failures.

Moreover, some implementations of static memory allocation strategies in NAND flash storage systems that are not dynamic pool compatible are constrained by a lack of flexibility in erase-program schemes. These erase-program schemes are often pre-defined and embedded at the firmware level and do not include erase-program schemes that involve transitioning blocks between different memory configurations (e.g., SLC, TLC, MLC, QLC, etc.). This rigidity can result from the lack of a mechanism to track the erase operations that were performed on a block during a single PEC. This prevents the adaptation of memory management strategies to diverse operational needs without overestimating the wear on a given block. As stated, some implementations have relied on overestimating wear ratios to err on the side of caution, which would inherently diminish the total writable bytes of a device by failing to accurately reflect the wear incurred by specific erase-program schemes, especially when transitioning between different memory configurations (e.g., SLC, MLC, TLC, QLC, etc.).

Aspects and implementations of the present disclosure address these and other deficiencies by implementing dynamic wear ratio management for dynamic pool compatible systems. By implementing dynamic wear ratio management, media endurance metric values (e.g., PEC counts) can be accurately tracked for dynamic pool compatible systems. For example, a controller of a memory device can store, in a register associated with the block, a value that represents an erase state of a block. The erase state can reflect the erase operations performed on the block during a current PEC of the block. The erase log can be updated in response to an erase operation being performed on the block and can be further updated with every subsequent erase operation performed on the block. In this way the erase log can represent the number and type (e.g., SLC, TLC, MLC, XLC, etc.) of erase operations performed on the block during the current PEC. While the PEC count can be incremented at the time of the erase operation, in some embodiments of the present disclosure, the PEC count is not incremented at the time of the erase operation. Instead, the erase log is updated and stored in the register at the time of an erase operation. Subsequently, when the block is programmed, the controller can determine a wear ratio based on the combination of the erase operations and the program operation performed on the block during the program-erase cycle.

In some embodiments, the wear ratio of two erase-program schemes refers to the relationship between the number of program-erase cycles performed on a block using the first erase-program scheme and the second number of program-erase cycles required for the second erase-program scheme to cause the same degree of cell degradation to the block. Wear ratios for between two erase-program schemes can be calculated using a PEC count for each scheme where the two schemes have similar data retention characteristics (e.g., a similar read window budget). For example, the wear ratio between two erase-program schemes A and B, can be calculated by determining a ratio between the PEC count of scheme A and scheme B at a certain read window budget.

In some embodiments, a reference scheme can be used to determine wear ratios for a given system. The reference scheme can be used to determine wear ratios for schemes A and B. For example, when calculating the wear ratio between multiple erase-program schemes, one scheme can be used as a reference. For example, if scheme A is used as the reference, the wear ratio indicates how scheme B compares to scheme A in terms of wear. For example, the wear ratio for scheme A can be a relatively high wear ratio (e.g., greater than 1), meaning a relatively smaller number of PECs of scheme A (e.g., 5 PECs) cause the same amount of wear as a relatively higher number of PECs (e.g., 10) of the reference scheme. The wear ratio for scheme B can be a relatively low wear ratio (e.g., less than 1), meaning a relatively higher number of PECs of scheme B (e.g., 8 PECs) cause the same amount of wear as a relatively lower number of PECs (e.g., 2) of the reference scheme.

In some embodiments, in SLC implementations, the reference scheme can be an SLC erase and an SLC program. In TLC implementations, the reference scheme can be a TLC erase and a TLC program. In QLC implementation, the reference scheme can be a QLC erase and QLC program, and so on.

In response to the controller determining the wear ratio for the current program erase scheme, the controller can increment a media endurance metric value (e.g., a PEC count) of the block by the determined wear ratio.

Advantages of the present disclosure include increased accuracy of media endurance metric values (e.g., PEC counts) by using dynamic wear ratio management for varying erase-program schemes, leading to increased lifespan of devices and avoidance of system failures due to overused blocks. Advantages of the present disclosure introduce a higher degree of flexibility and adaptability to dynamic pool management in NAND flash memory systems. For example, a more diverse array of erase-program schemes (e.g., erase program schemes involving transitioning between different cell technologies) can be pre-defined and embedded at the firmware level using accurate media endurance metric value (e.g., PEC count) increments based on dynamic wear ratios. Advantages of the present disclosure include adaptation of memory management strategies to diverse operational needs, without sacrificing wear ratio and media endurance metric value accuracy, leading to increased efficiency, reliability, and longevity of memory devices.

FIG. 1A illustrates an example computing system 100 that includes a memory sub-system 110 in accordance with some embodiments of the present disclosure. The memory sub-system 110 can include media, such as one or more volatile memory devices (e.g., memory device 140), one or more non-volatile memory devices (e.g., memory device 130), or a combination of such. Each memory device 130 or 140 can be one or more memory component(s).

A memory sub-system 110 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory module (NVDIMM).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to different types of memory sub-system 110. FIG. 1A illustrates one example of a host system 120 coupled to one memory sub-system 110. As used herein, “coupled to” or “coupled with” generally refers to a connection between components or devices, which can be an indirect communicative connection or direct communicative connection (e.g., without intervening components or devices), whether wired or wireless, including connections such as electrical, optical, magnetic, and the like.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller, CXL controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a serial advanced technology attachment (SATA) interface, a compute express link (CXL) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access components (e.g., memory devices 130) when the memory sub-system 110 is coupled with the host system 120 by the physical host interface (e.g., PCIe or CXL bus). The physical host interface can provide an interface for passing control, address, data, and other signals between the memory sub-system 110 and the host system 120. FIG. 1A illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include NOT-AND (NAND) type flash memory and write-in-place memory, such as three-dimensional cross-point (“3D cross-point”) memory. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 130 can include one or more arrays of memory cells. One type of memory cell, for example, single level cells (SLC) can store one bit per cell. Other types of MLC memory cells, such as bi-level cells (BLCs), triple-level cells (TLCs), quad-level cells (QLCs), and penta-level cells (PLCs) can store multiple bits per cell. In some embodiments, each of the memory devices 130 can include one or more arrays of memory cells such as SLCs, BLCs, TLCs, QLCs, PLCs or any combination of such. In some embodiments, a particular memory device can include an SLC portion, and an BLC portion, a TLC portion, or a QLC portion of memory cells. The memory cells of the memory devices 130 can be grouped as pages that can refer to a logical unit of the memory device used to store data. With some types of memory (e.g., NAND), pages can be grouped to form blocks.

In some embodiments, the memory devices 130 can be dynamic pool compatible, meaning that blocks of memory devices 130 can be organized into dynamic pools (e.g., logical groups of blocks) that can allow for the flexible allocation and reallocation of memory resources based on data storage and access requirements of host system 120. Dynamic pools enable the system 100 to adaptively manage data storage by increasing or decreasing dynamic pool sizes by converting blocks of one type of memory cell to another type of memory cell (e.g., SLC to TLC, TLC to QLC, PLC to SLC, etc.). For example, by decreasing the size of a dynamic pool of blocks of a first type of cell and increasing the size of a dynamic pool of blocks of a second type of cell performance can be improved. Alternatively, other changes to dynamic pools can be made to increase endurance and/or storage efficiency.

Although non-volatile memory components such as NAND type flash memory (e.g., 2D NAND, 3D NAND) and 3D cross-point array of non-volatile memory cells are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), NOT-OR (NOR) flash memory, and electrically erasable programmable read-only memory (EEPROM).

A memory sub-system controller 115 (or controller 115 for simplicity) can communicate with the memory devices 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processor 117 (e.g., processing device) configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1A has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory devices 130. The memory sub-system controller 115 can be responsible for other operations such as wear leveling operations, garbage collection operations, error detection and error-correcting code (ECC) operations, encryption operations, caching operations, and address translations between a logical block address (e.g., logical block address (LBA), namespace) and a physical address (e.g., physical block address) that are associated with the memory devices 130. The memory sub-system controller 115 can further include host interface circuitry to communicate with the host system 120 via the physical host interface. The host interface circuitry can convert the commands received from the host system into command instructions to access the memory devices 130 as well as convert responses associated with the memory devices 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory devices 130.

In some embodiments, the memory devices 130 include local media controllers 135 that operate in conjunction with memory sub-system controller 115 to execute operations on one or more memory cells of the memory devices 130. An external controller (e.g., memory sub-system controller 115) can externally manage the memory device 130 (e.g., perform media management operations on the memory device 130). In some embodiments, the memory devices 130 are managed memory devices, which is a raw memory device combined with a local controller (e.g., the local media controller 135) for memory management within the same memory device package or memory die. An example of a managed memory device is a managed NAND (MNAND) device. Memory device 130, for example, can represent a single die or multiple dice having some control logic (e.g., local media controller 135) embodied thereon. In some embodiments, the memory device 130 includes the local media controller 135 and a memory array 104 coupled to the local media controller 135. In some embodiments, one or more components of the memory sub-system 110 are omitted.

In some embodiments, the controller 115 includes an error-correcting code (ECC) encoder/decoder 111. The ECC encoder/decoder 111 can perform ECC encoding for data written to the memory devices 130 and ECC decoding for data read from the memory devices 130, respectively. The ECC decoding can be performed to decode an ECC codeword to correct errors in the raw read data, and in many cases also to report the number of bit errors in the raw read data.

The memory sub-system 110 includes a dynamic wear ratio component 113 that can implement dynamic wear ratio management for dynamic pool compatible systems. In some embodiments, the memory sub-system controller 115 includes at least a portion of the dynamic wear ratio component 113. In some embodiments, the dynamic wear ratio component 113 is part of the host system 120, an application, or an operating system. In other embodiments, local media controller 135 includes at least a portion of dynamic wear ratio component 113 and is configured to perform the functionality described herein.

The dynamic wear ratio component 113 can implement dynamic wear ratio management for dynamic pool compatible systems. For example, dynamic wear ratio component 113 can update a value reflecting a type and a corresponding number of erase operations performed on a block of the memory device 130 in a metadata structure 150 associated with the block in response to an erase operation being performed on the block of the memory device 130. In some embodiments, memory sub-system 110 can include a plurality of blocks and each block can have an associated metadata structure (e.g., implemented as a register). The dynamic wear ratio component 113 can retrieve the value reflecting the type and the corresponding number of erase operations performed on the block of the memory device 130 in response to a program operation being performed on the block of memory device 130. The dynamic wear ratio component 113 can determine a wear ratio based on the value reflecting the type and the corresponding number of erase operations and the program operation performed on the block. The dynamic wear ratio component 113 can update a media endurance metric value (e.g., a PEC count) of the block of the memory device 130 based on the determined wear ratio.

In some embodiments, a metadata structure can refer to a system for organizing data that describes the characteristics, conditions, or attributes of other data. Metadata structure 150, associated with a block of memory device 130, can store information about the type and the corresponding number of erase operations performed on the block. Storage of such metadata in metadata structure 150 enables dynamic wear ratio component 113 to retrieving the value reflecting the type and the corresponding number of erase operations performed on the block of the memory device (e.g., since the last program operation performed on the block) and to determining a wear ratio based on the value reflecting the type and the corresponding number of erase operations and the program operation. dynamic wear ratio component 113 can then update, based on the determined wear ratio, a media endurance metric value (e.g., PEC count) of the block of the memory device.

In some embodiments, metadata structure 150 can be implemented as a register within the memory sub-system 110 or memory device. In some embodiments, the metadata structure 150 is a block-level register (e.g., associate with a block of the memory device 130). By storing metadata in a block-level metadata register 150, the memory sub-system controller 115 and/or dynamic wear ratio component can rapidly retrieve the value stored in metadata register 150 and update a media endurance metric value (e.g., PEC count) of the block, facilitating quicker and more accurate PEC tracking.

In some embodiments, the dynamic wear ratio component 113 can determine whether the media endurance metric value (e.g., PEC count) of the block of the memory device satisfies a threshold criterion based on a threshold value. The dynamic wear ratio component 113 can retire the block from use in the memory device 130 in response to determining that the media endurance metric value (e.g., PEC count) of the block satisfies the threshold criterion. Alternatively, the dynamic wear ratio component 113 can allocate the block for continued use in the memory device 130 in response to determining that the media endurance metric value (e.g., PEC count) of the block does not satisfy the threshold criterion.

Further details with regards to the operations of the dynamic wear ratio component 113 are described below.

The dynamic wear ratio component 113 can be responsible for handling interactions of the memory sub-system controller 115 with the memory devices of the memory sub-system 110, such as the memory device 130. For example, the dynamic wear ratio component 113 can send memory access commands corresponding to requests received from the host system 120 to the memory device 130, such as program commands, read commands, or other commands. In addition, the dynamic wear ratio component 113 can receive data from the memory device 130, such as data retrieved in response to a read command or a confirmation that a program command was successfully performed. In some embodiments, the memory sub-system controller 115 includes at least a portion of the dynamic wear ratio component 113. For example, the controller 115 can include a processor 117 (e.g., a processing device) configured to execute instructions stored in the local memory 119 for performing the operations described herein. In some embodiments, the dynamic wear ratio component 113 is part of the host system 120, an application, or an operating system.

FIG. 1B is a simplified block diagram of a first apparatus, in the form of a memory device 130, in communication with a second apparatus, in the form of a memory sub-system controller 115 of a memory sub-system (e.g., memory sub-system 110 of FIG. 1A), according to an embodiment. Some examples of electronic systems include personal computers, personal digital assistants (PDAs), digital cameras, digital media players, digital recorders, games, appliances, vehicles, wireless devices, mobile telephones and the like. The memory sub-system controller 115 (e.g., a controller external to the memory device 130), may be a memory controller or other external host device.

Memory device 130 includes an array of memory cells 104 logically arranged in rows and columns. Memory cells of a logical row are typically connected to the same access line (e.g., a wordline) while memory cells of a logical column are typically selectively connected to the same data line (e.g., a bit line). A single access line may be associated with more than one logical row of memory cells and a single data line may be associated with more than one logical column. Memory cells (not shown in FIG. 1B) of at least a portion of array of memory cells 104 are capable of being programmed to one of at least two target data states.

Row decode circuitry 108 and column decode circuitry 109 are provided to decode address signals. Address signals are received and decoded to access the array of memory cells 104. Memory device 130 also includes input/output (I/O) control circuitry 160 to manage input of commands, addresses and data to the memory device 130 as well as output of data and status information from the memory device 130. An address register 114 is in communication with I/O control circuitry 160 and row decode circuitry 108 and column decode circuitry 109 to latch the address signals prior to decoding. A command register 124 is in communication with I/O control circuitry 160 and local media controller 135 to latch incoming commands.

A controller (e.g., the local media controller 135 internal to the memory device 130) controls access to the array of memory cells 104 in response to the commands and generates status information for the external memory sub-system controller 115, i.e., the local media controller 135 is configured to perform access operations (e.g., read operations, programming operations and/or erase operations) on the array of memory cells 104. The local media controller 135 is in communication with row decode circuitry 108 and column decode circuitry 109 to control the row decode circuitry 108 and column decode circuitry 109 in response to the addresses. In one embodiment, local media controller 135 can implement dynamic wear ratio management for dynamic pool compatible systems by determining a wear ratio of an erase-program scheme based on the type and the corresponding number of erase operations and the program operation performed on a block of memory array 104 during a PEC.

The local media controller 135 is also in communication with a cache register 172. Cache register 172 latches data, either incoming or outgoing, as directed by the local media controller 135 to temporarily store data while the array of memory cells 104 is busy writing or reading, respectively, other data. During a program operation (e.g., write operation), data may be passed from the cache register 172 to the data register 170 for transfer to the array of memory cells 104; then new data may be latched in the cache register 172 from the I/O control circuitry 160. During a read operation, data may be passed from the cache register 172 to the I/O control circuitry 160 for output to the memory sub-system controller 115; then new data may be passed from the data register 170 to the cache register 172. The cache register 172 and/or the data register 170 may form (e.g., may form a portion of) a page buffer of the memory device 130. A page buffer may further include sensing devices (not shown in FIG. 1B) to sense a data state of a memory cell of the array of memory cells 104, e.g., by sensing a state of a data line connected to that memory cell. A status register 122 may be in communication with I/O control circuitry 160 and the local memory controller 135 to latch the status information for output to the memory sub-system controller 115.

Memory device 130 receives control signals at the memory sub-system controller 115 from the local media controller 135 over a control link 132. For example, the control signals can include a chip enable signal CE #, a command latch enable signal CLE, an address latch enable signal ALE, a write enable signal WE #, a read enable signal RE #, and a write protect signal WP #. Additional or alternative control signals (not shown) may be further received over control link 132 depending upon the nature of the memory device 130. In one embodiment, memory device 130 receives command signals (which represent commands), address signals (which represent addresses), and data signals (which represent data) from the memory sub-system controller 115 over a multiplexed input/output (I/O) bus 134 and outputs data to the memory sub-system controller 115 over I/O bus 134.

For example, the commands may be received over input/output (I/O) pins [7:0] of I/O bus 134 at I/O control circuitry 160 and may then be written into command register 124. The addresses may be received over input/output (I/O) pins [7:0] of I/O bus 134 at I/O control circuitry 160 and may then be written into address register 114. The data may be received over input/output (I/O) pins [7:0] for an 8-bit device or input/output (I/O) pins [15:0] for a 16-bit device at I/O control circuitry 160 and then may be written into cache register 172. The data may be subsequently written into data register 170 for programming the array of memory cells 104.

In an embodiment, cache register 172 may be omitted, and the data may be written directly into data register 170. Data may also be output over input/output (I/O) pins [7:0] for an 8-bit device or input/output (I/O) pins [15:0] for a 16-bit device. Although reference may be made to I/O pins, they may include any conductive node providing for electrical connection to the memory device 130 by an external device (e.g., the memory sub-system controller 115), such as conductive pads or conductive bumps as are commonly used.

It will be appreciated by those skilled in the art that additional circuitry and signals can be provided, and that the memory device 130 of FIG. 1B has been simplified. It should be recognized that the functionality of the various block components described with reference to FIG. 1B may not necessarily be segregated to distinct components or component portions of an integrated circuit device. For example, a single component or component portion of an integrated circuit device could be adapted to perform the functionality of more than one block component of FIG. 1B. Alternatively, one or more components or component portions of an integrated circuit device could be combined to perform the functionality of a single block component of FIG. 1B. Additionally, while specific I/O pins are described in accordance with popular conventions for receipt and output of the various signals, it is noted that other combinations or numbers of I/O pins (or other I/O node structures) may be used in the various embodiments.

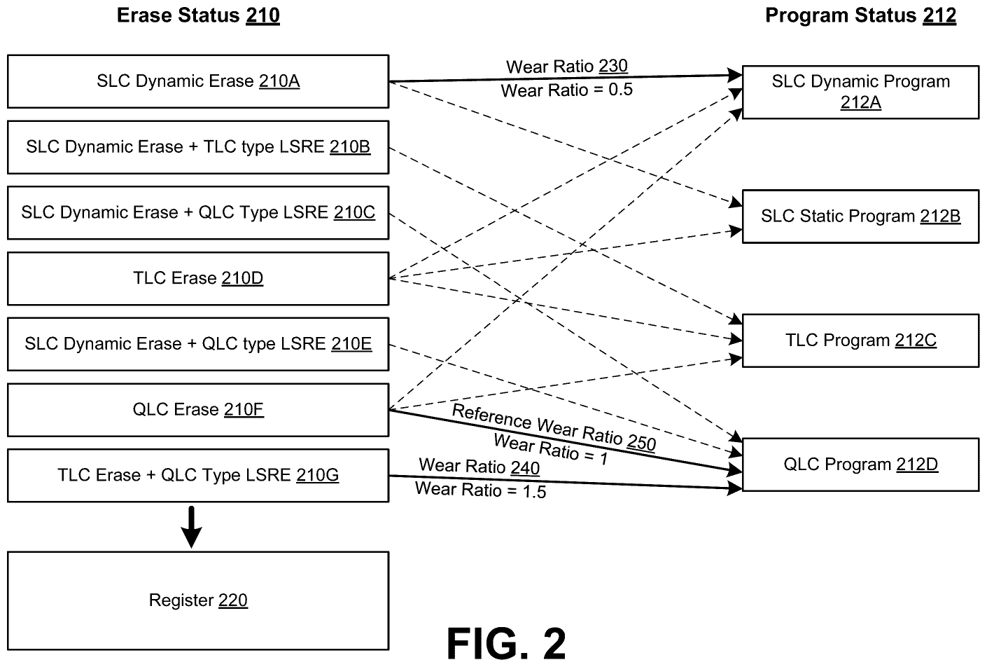

FIG. 2 illustrates dynamic wear ratio management in a QLC die of a memory device, according to various embodiments. In some embodiments, a dynamic pool compatible QLC die can include SLC, TLC, and QLC dynamic pools. A memory system can be free to reconfigure any block of the dynamic pool compatible QLC die as any one of SLC, TLC, or QLC. In some embodiments, dynamic wear ratio management enables increase system flexibility by tracking a erase status 210 in order to determine an accurate wear ratio for each PEC of a block.

In some embodiments, by implementing dynamic wear ratio management for dynamic pool compatible systems, a media endurance metric value (e.g., PEC count) of a block can be accurately tracked. For example, a controller of an memory device can update a value (e.g., a binary value) that represents an erase status 210 of a block. The value can be stored in a register 220 associated with the block. The erase status 210 can represent the erase operations performed on the block during a current PEC of the block. In some embodiments, the value representing the erase status 210 of the block indicates the types and corresponding numbers of erase operations performed on the block during the current PEC of the block. The media endurance metric value (e.g., PEC count) of the block can be updated following each PEC (e.g., updated in response to a program operation being performed on the block). In some embodiments, erase status 210 can include the erase operations performed on the block since the last program operation performed on the block. In some embodiments, register 220 can be updated in response to each erase operation performed on the block. In some embodiments, the erase status can be reset (e.g., indicating that no erase operations have be performed on the block during the current PEC) in response to updating the media endurance metric value (e.g., PEC count) of the block. In some embodiments, the erase status is reset when the block is programmed.

The erase status 210 can be updated in response to an erase operation being performed on the block and can be further updated with every subsequent erase operation performed on the block. For example, erase status 210F of a block includes a QLC erase operation. A value representing erase status 210F can be stored in register 220. In some embodiments, the block was pre-erased as a QLC type (e.g., for use in a QLC dynamic pool). However, due to data storage requirements of a host system the block can be reconfigured as a QLC block and added to a QLC dynamic pool. In response to a QLC type LSRE operation being performed on the block (e.g., to reconfigure the block as QLC type) the value representing the erase status 210 of the block can be updated (e.g., in the register) to erase status 210G, reflecting an TLC Erase and a QLC type LSRE. By updating the value representing erase status 210 with each erase operation performed on the block, the value can accurately represent the type (e.g., SLC, TLC, MLC, XLC, etc.) and corresponding number of erase operations performed on the block (e.g., at the time a program operation is performed on the block). In some embodiments, LSREs can be a soft touch erase to issue single erase pules on a targeted block. An LSRE is typically applied on a previously erased block where the erase-level was not deep enough. In a typical erase operation (e.g., non-LSRE), one program pulse is applied before an erase pulse, which unifies erase operations but causes more cell damage.

In some embodiments, a program operation is performed on the block. The controller can retrieve the value reflecting the erase status 210G and determine a wear ratio based on the value reflecting erase status 210G and the program operation. For example, a QLC program 212D can be performed on the block. A program status 212 can reflect the program status 212D. The controller can determine that the wear ratio is wear ratio 240 (e.g., 1.5) based on the value reflecting erase status 210G and the program status 212D.

In some embodiments, wear ratios for erase-program schemes can be predetermined. A wear ratio can reflect the relationship between a first number of program-erase cycles performed on a block using a first reference erase-program scheme (e.g., QLC erase 210F followed by QLC program 212D) and a second number of program-erase cycles required for a second erase-program scheme (e.g., SLC dynamic erase 210A followed by SLC dynamic program 212A) to cause the same amount of cell degradation or wear to a block. In some embodiments, media endurance metric value (e.g., PEC count) are tracked in terms of a PEC of the reference scheme. For example, the first reference erase-program scheme (e.g., QLC erase 210F followed by QLC program 212D) has a wear ratio 250 that is equal to 1 QLC PEC and a wear ratio 230 is equal to 0.5 QLC PECs. Wear ratio corresponds to the second erase-program scheme (e.g., SLC dynamic erase 210A followed by SLC dynamic program 212A). Wear ratio 240 is equal to 1.5 QLC PECs and can correspond to a third erase-program scheme (e.g., TLC erase 210A followed by QLC type LSRE 212G). Each wear ratio 230 and 240 can be a measure that compares the amount of cell degradation or wear to a block (e.g., measured in QLC PECs) caused by the second and third erase-program schemes respectively.

In SLC implementations, the reference scheme can be an SLC erase and an SLC program. In TLC implementations, the reference scheme can be a TLC erase and a TLC program. In QLC implementation, the reference scheme can be a QLC erase and QLC program, and so on. In some embodiments, the WR is tracked at the block level, and it is recalculated after a block is programed with a different erase-program scheme. The PEC count of the block can be the aggregation of the PEC count before the different erase-program scheme and the calculated WR.

In some embodiments, after determining a wear ratio based on the value reflecting, for example, erase status 210G and the program status 212D the controller can update, based on the determined wear ratio, a media endurance metric value (e.g., PEC count) of the block of the memory device. For example, the wear ratio for the combination of erase status 210G and program status 212D is wear ratio 240, being equal to 1.5 QLC PECs. The controller can increment the media endurance metric value (e.g., PEC count) of the block of the memory device by 1.5 (e.g., wear ratio 240).

In some embodiments, following the updating of the media endurance metric value (e.g., the PEC count) of the block of the memory device (e.g., by incrementing the PEC count by the wear ratio) the controller can determine whether the media endurance metric value of the block of the memory device satisfies a threshold criterion based on a threshold value. In some embodiments, the threshold value is a number of PECs. In some embodiments, a PEC threshold criterion may be a logical condition (e.g., a PEC value must be greater than or equal to a certain number of PECs (e.g., a PEC threshold value) for the threshold criterion to be satisfied. In some embodiments, for example, the end of life (EOL) for a QLC memory cell may be associated with a certain number of PECs. For example, if a media endurance metric value (e.g., PEC count) of the block is greater than or equal to the threshold value the media endurance metric value (e.g., PEC count) of the block satisfies the threshold criterion. If a media endurance metric value (e.g., PEC count) of the block is less than the threshold value the block does not satisfy the threshold criterion.

In these embodiments, the threshold criterion may be based on a threshold value (e.g., a fixed PEC value, media endurance metric value, and/or the like). For example, a threshold value may be equal to a fixed number of PECs or another media endurance metric (e.g., a threshold value may be determined based on statistical data collected in post-production testing, such that the determined threshold value would optimize chosen performance or endurance metric(s)). In these and other embodiments, a threshold criterion is satisfied if the media endurance metric value is greater than (or greater than or equal to) the threshold value. In these and other embodiments, a threshold criterion is not satisfied when the media endurance metric value is less than the threshold value. In some embodiments, the threshold value and media endurance metric value may include an indication of a relative value between the two values (e.g., the media endurance metric value being less than the threshold value by a percentage).

In some embodiments, a wear ratio can be a measure that compares the amount of cell degradation or wear to a block caused by different erase-program schemes. A wear ratio between two erase-program schemes can be calculated using a media endurance metric value (e.g., PEC counts) for each scheme, where the two schemes have similar data retention characteristics (e.g., a similar read window budget). For example, the wear ratio between two erase-program schemes A and B, can be calculated by determining a ratio between the media endurance metric value (e.g., PEC count) of scheme A and scheme B at a certain read window budget. When calculating the wear ratio between multiple erase-program schemes, one scheme can be used as a reference. For example, if scheme A is used as the reference, the wear ratio indicates how scheme B compares to scheme A in terms of wear. For example, the wear ratio can be represented by the equation:

$$wear ratio ( W R ) = \frac{Scheme A PEC Count}{Scheme B PEC Count}$$

where the scheme A PEC count and the scheme B PEC count were taken with the same or a similar read window budget (e.g., after a data retention bake). If the wear ratio is less than one then scheme B has slower degradation than scheme A cycling. If the wear ratio is greater than one then scheme B has faster degradation than scheme A cycling.

In some embodiments, the determined wear ratios can be used to accurately increment media endurance metric values (e.g., PEC count) of blocks following different erase-program schemes (e.g., distinct combinations of erase status 210 and program status 212). In some embodiments, the wear ratio is added to the media endurance metric value (e.g., PEC count) of a block to increment the media endurance metric value. For example, a block having a PEC count of 50 and may undergo a erase-program scheme including erase status 210G and program status 212D. In such a scenario, the erase-program scheme has a wear ratio 240 that is equal to 1.5. The PEC count of the block would be incremented by 1.5 resulting in a PEC count of 51.5.

In some embodiments, a host system can request a certain erase-program scheme based on the host system requirements at a current moment and based on the overall best block budgeting. For example, if the host system requires increased performance a TLC pre-erase 210D+an SLC dynamic program 212A can be applied with the tradeoff of the more cell damage (compared to SLC dynamic erase 210A+SLC dynamic program 212A). In some embodiments, if reliability is required a TLC erase 210D+an SLC static program 212B can be applied. In some embodiments, a TLC erase 210D+a TLC program 212C can provide increased drive capacity.

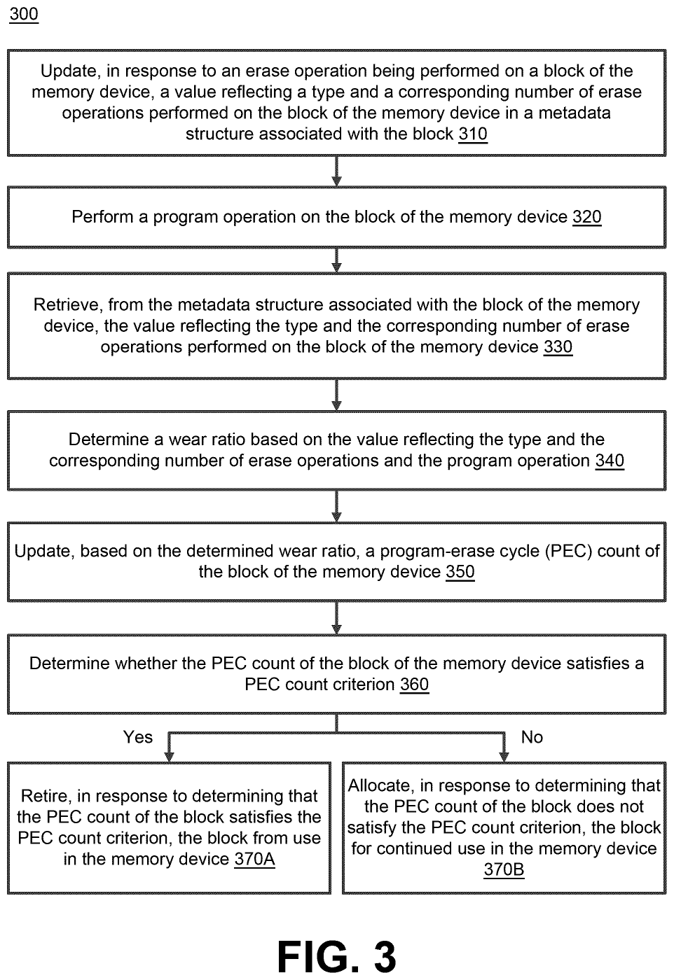

FIG. 3 is a flow chart of a method 300 for dynamic wear ratio management for dynamic pool compatible systems, according to various embodiments. The method 300 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 300 is performed by the controller 115 (e.g., dynamic wear ratio component 113) and/or the local media controller 135 of FIGS. 1A-1B. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 310, the processing logic updates, in response to an erase operation being performed on the block, a value reflecting a type and a corresponding number of erase operations performed on the block of the memory device in a metadata structure associated with the block. In some embodiments, each block of the memory device can have an associated metadata structure.

At operation 320, processing logic performs a program operation on the block of the memory device.

At operation 330, the processing logic retrieves, from the metadata structure associated with the block of the memory device, the value reflecting the type and the corresponding number of erase operations performed on the block of the memory device.

At operation 340, the processing logic determines a wear ratio based on the value reflecting the type and the corresponding number of erase operations and the program operation. In some embodiments, the type and the corresponding number of erase operations performed on the block comprise erase operations performed on the block during a first PEC.

In some embodiments, the wear ratio represents a relationship between a first number of PECs of a first erase-program scheme that causes a first amount of cell damage to the block and a second number of PECs of a second erase-program scheme that causes a second amount of cell damage to a block, wherein a difference between the first amount of cell damage and the second amount of cell damage is less than a predefined threshold. In some embodiments, the predefined threshold can be a threshold number of PEC cycles.

At operation 350, the processing logic updates, based on the determined wear ratio, a (PEC) count of the block of the memory device.

At operation 360, the processing logic determines whether the media endurance metric value (e.g., PEC count) of the block of the memory device satisfies a threshold criterion based on a threshold value.

At operation 370A, the processing logic retires, in response to determining that the media endurance metric value (e.g., PEC count) of the block satisfies the threshold criterion, the block from use in the memory device. In some instances, the processing logic may delay the retirement of the block and continue using it for at least a predefined number of program-erase cycles.

In some embodiments, the processing logic can use wear leveling techniques to distribute PECs evenly across all blocks (e.g., so that no single block is overused). This helps to maintain the overall health and efficiency of the memory device. In some embodiments, in response to a PEC count of a block approaching or reaching a predefined threshold (e.g., satisfying the threshold criterion), the processing logic may elect to utilize the block for further operations. This flexibility allows for better optimization of memory resources of the memory device, particularly in scenarios where immediate data storage is prioritized over long-term reliability. Continuing to use a block beyond its typical wear threshold may compromise the reliability of the data stored in the block. In some embodiments, the processing logic can mitigate risk of data loss by, for example, using such blocks for less critical data or temporary data storage. In some embodiments, the processing logic may not determine to retire a memory block based solely on the PEC count of the block. For example, the decision to retire a memory block can be based on error rates of a block (e.g., a program status failure (PSF) count of the block), data retention capabilities of a block, performance metrics of a block, etc.

At operation 370B, the processing logic allocates, in response to determining that the media endurance metric value (e.g., PEC count) of the block does not satisfy the threshold criterion, the block for continued use in the memory device.

In some embodiments, the memory device includes a plurality of dynamically reconfigurable blocks. In some embodiments, the method further includes reconfiguring, based on data storage requirements of a host system, at least a portion of the plurality of dynamically reconfigurable blocks. In some embodiments, the processing logic can reconfigure (e.g., convert a block from one dynamic pool to another) any block of the plurality of blocks and achieve more total bytes written for a device because the wear ratio tracking is accurate.

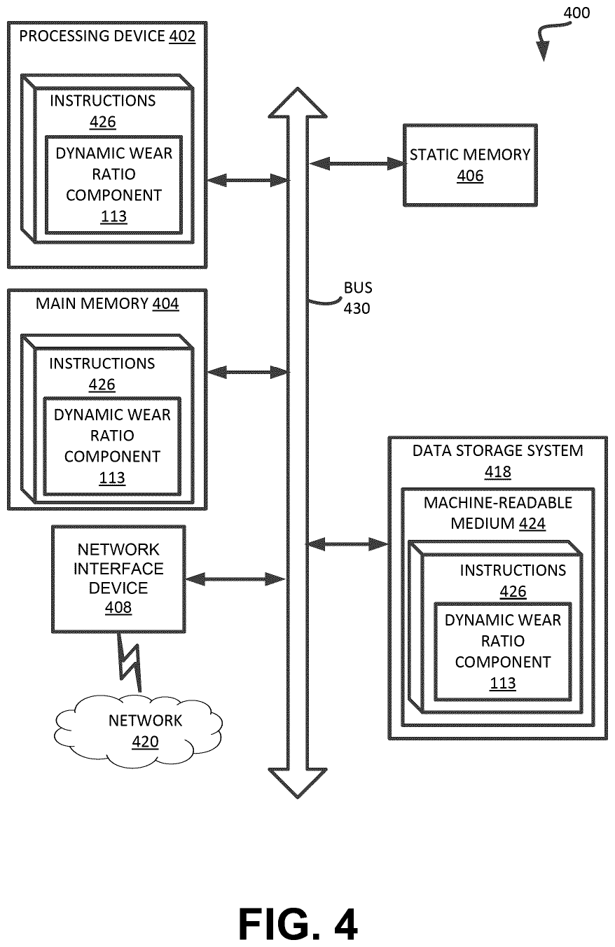

FIG. 4 illustrates an example machine of a computer system 400 within which a set of instructions, for causing the machine to perform any one or more of the methodologies discussed herein, can be executed. In some embodiments, the computer system 400 can correspond to a host system (e.g., the host system 120 of FIG. 1A) that includes, is coupled to, or utilizes a memory sub-system (e.g., the memory sub-system 110 of FIG. 1A). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 400 includes a processing device 402, a main memory 404 (e.g., read-only memory (ROM), flash memory, dynamic random access memory (DRAM) such as synchronous DRAM (SDRAM) or Rambus DRAM (RDRAM), etc.), a static memory 406 (e.g., flash memory, static random access memory (SRAM), etc.), and a data storage system 418, which communicate with each other via a bus 430.

Processing device 402 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 402 can also be one or more special-purpose processing devices such as an application specific integrated circuit (ASIC), a field programmable gate array (FPGA), a digital signal processor (DSP), network processor, or the like. The processing device 402 is configured to execute instructions 426 for performing the operations and steps discussed herein. The computer system 400 can further include a network interface device 408 to communicate over the network 420.

The data storage system 418 can include a machine-readable storage medium 424 (also known as a computer-readable medium) on which is stored one or more sets of instructions 426 or software embodying any one or more of the methodologies or functions described herein. The instructions 426 can also reside, completely or at least partially, within the main memory 404 and/or within the processing device 402 during execution thereof by the computer system 400, the main memory 404 and the processing device 402 also constituting machine-readable storage media. The machine-readable storage medium 424, data storage system 418, and/or main memory 404 can correspond to the memory sub-system 110 of FIGS. 1A-1B.

In one embodiment, the instructions 426 include instructions to implement functionality corresponding to dynamic wear ratio component 113 of FIG. 1A. While the machine-readable storage medium 424 is shown in an example embodiment to be a single medium, the term “non-transitory computer-readable storage medium” should be taken to include a single medium or multiple media that store the one or more sets of instructions. The term “machine-readable storage medium” or “computer-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A system, comprising:
a memory device; and
a processing device operatively coupled to the memory device, the processing device to perform operations, comprising:
performing a program operation on a block of the memory device;
retrieving, from a metadata structure associated with a block of the memory device, a value reflecting a type and a corresponding number of erase operations performed on the block of the memory device;
determining a wear ratio based on the value reflecting the type and the corresponding number of erase operations and the program operation; and
updating, based on the determined wear ratio, a media endurance metric value of the block of the memory device.

2. The system of claim 1, wherein the operations further comprise:
updating, in response to an erase operation being performed on the block, the value reflecting the type and the corresponding number of erase operations performed on the block of the memory device.

3. The system of claim 1, wherein the wear ratio represents a relationship between a first number of PECs of a first erase-program scheme that causes a first amount of cell damage to a block and a second number of PECs of a second erase-program scheme that causes a second amount of cell damage to a block, wherein a difference between the first amount of cell damage and the second amount of cell damage is less than a predefined threshold.

4. The system of claim 1, wherein the memory device comprises a plurality of dynamically reconfigurable blocks, and wherein the operations further comprise:
reconfiguring, based on data storage requirements of a host system, at least a portion of the plurality of dynamically reconfigurable blocks.

5. The system of claim 1, wherein the type and the corresponding number of erase operations performed on the block comprise erase operations performed on the block during a first PEC.

6. The system of claim 1, wherein the operations further comprise:
determining whether the media endurance metric value of the block of the memory device satisfies a threshold criterion based on a threshold value; and
retiring, in response to determining that the media endurance metric value of the block satisfies the threshold criterion, the block from use in the memory device.

7. The system of claim 1, wherein the operations further comprise:
determining whether the media endurance metric value of the block of the memory device satisfies a threshold criterion based on a threshold value; and
allocating, in response to determining that the media endurance metric value of the block does not satisfy the threshold criterion, the block for continued use in the memory device.

8. A method, comprising:
performing, by a processing device, a program operation on a block of a memory device;
retrieving, from a metadata structure associated with the block of the memory device, a value reflecting a type and a corresponding number of erase operations performed on the block of the memory device;
determining a wear ratio based on the value reflecting the type and the corresponding number of erase operations and the program operation; and
updating, based on the determined wear ratio, a media endurance metric value of the block of the memory device.

9. The method of claim 8, further comprising:
updating, in response to an erase operation being performed on the block, the value reflecting the type and the corresponding number of erase operations performed on the block of the memory device.

10. The method of claim 8, wherein the wear ratio represents a relationship between a first number of PECs of a first erase-program scheme that causes a first amount of cell damage to a block and a second number of PECs of a second erase-program scheme that causes a second amount of cell damage to a block, wherein a difference between the first amount of cell damage and the second amount of cell damage is less than a predefined threshold.

11. The method of claim 8, wherein the memory device comprises a plurality of dynamically reconfigurable blocks, and wherein the method further comprises:
reconfiguring, based on data storage requirements of a host system, at least a portion of the plurality of dynamically reconfigurable blocks.

12. The method of claim 8, wherein the type and the corresponding number of erase operations performed on the block comprise erase operations performed on the block during a first PEC.

13. The method of claim 8, further comprising:
determining whether the media endurance metric value of the block of the memory device satisfies a threshold criterion based on a threshold value; and
retiring, in response to determining that the media endurance metric value of the block satisfies the threshold criterion, the block from use in the memory device.

14. The method of claim 8, further comprising:
determining whether the media endurance metric value of the block of the memory device satisfies a threshold criterion based on a threshold value; and
allocating, in response to determining that the media endurance metric value of the block does not satisfy the threshold criterion, the block for continued use in the memory device.

15. A non-transitory computer-readable storage medium storing instructions, which when executed by a processing device, cause the processing device to perform operations comprising:
performing a program operation on a block of a memory device;
retrieving, from a metadata structure associated with the block of the memory device, a value reflecting a type and a corresponding number of erase operations performed on the block of the memory device;
determining a wear ratio based on the value reflecting the type and the corresponding number of erase operations and the program operation; and
updating, based on the determined wear ratio, a media endurance metric value of the block of the memory device.

16. The non-transitory computer-readable storage medium of claim 15, wherein the operations further comprise:
updating, in response to an erase operation being performed on the block, the value reflecting the type and the corresponding number of erase operations performed on the block of the memory device.

17. The non-transitory computer-readable storage medium of claim 15, wherein the memory device comprises a plurality of dynamically reconfigurable blocks, and wherein the operations further comprise:
reconfiguring, based on data storage requirements of a host system, at least a portion of the plurality of dynamically reconfigurable blocks.

18. The non-transitory computer-readable storage medium of claim 15, wherein the type and the corresponding number of erase operations performed on the block comprise erase operations performed on the block during a first PEC.

19. The non-transitory computer-readable storage medium of claim 15, wherein the operations further comprise:
determining whether the media endurance metric value of the block of the memory device satisfies a threshold criterion based on a threshold value; and
retiring, in response to determining that the media endurance metric value of the block satisfies the threshold criterion, the block from use in the memory device.

20. The non-transitory computer-readable storage medium of claim 15, wherein the operations further comprise:
determining whether the media endurance metric value of the block of the memory device satisfies a threshold criterion based on a threshold value; and
allocating, in response to determining that the media endurance metric value of the block does not satisfy the threshold criterion, the block for continued use in the memory device.
